(19) United States
(12) Patent Application Publication
(10) Pub. No.: US 2014/0185292 A1
(43) Pub. Date: Jul. 3, 2014

(54) HOUSING FOR ELECTRONIC DEVICE

(71) Applicants: FIH (Hong Kong) Limited, Kowloon (HK); SHENZHEN FUTAIHONG PRECISION INDUSTRY CO., LTD., Shenzhen (CN)

(72) Inventors: XU LIU, Shenzhen (CN); XING-HUA HAN, Shenzhen (CN)

(21) Appl. No.: 13/924,708

(22) Filed: Jun. 24, 2013

(30) Foreign Application Priority Data
Dec. 29, 2012 (CN) 201210588591X

(51) Int. Cl. F21V 15/01

(52) U.S. Cl. CPC F21V 15/01
USPC 362/249.02

(57) ABSTRACT

A housing of an electronic device includes a frame having a plurality of first opposite and second opposite sets of, a front cover, and a rear cover. The front cover and the rear cover are attached to two opposite sides of the frame to define a receiving space. The frame is made of wood. At least one sidewall defines at least one through groove. A transparent plastic article is engaged in each through groove. At least one LED lamp is located in the receiving space, and each LED lamp faces the one transparent plastic article.

### BACKGROUND

1. Technical Field

The present disclosure generally relates to a housing for an electronic device.

2. Description of Related Art

Housings for portable electronic devices (such as mobile phones, tablet computers, for example) are usually made of plastic or metal material. However, the plastic or metal housings can't present a novel and appealing appearance.

Therefore, there is room for improvement within the art.

### BRIEF DESCRIPTION OF THE FIGURE

Many aspects of the housing can be better understood with reference to the following drawings. The components in the drawings are not necessarily drawn to scale, the emphasis instead being placed upon clearly illustrating the principles of the housing. Moreover, in the drawings like reference numerals designate corresponding parts throughout the several views. Wherever possible, the same reference numbers are used throughout the drawings to refer to the same or like elements of an embodiment.

FIG. 1 is an exploded view of an exemplary housing.

FIG. 2 is a partly assembled, isometric view of the housing of FIG. 1.

FIG. 3 is an assembled view of the housing of FIG. 1.

### DETAILED DESCRIPTION

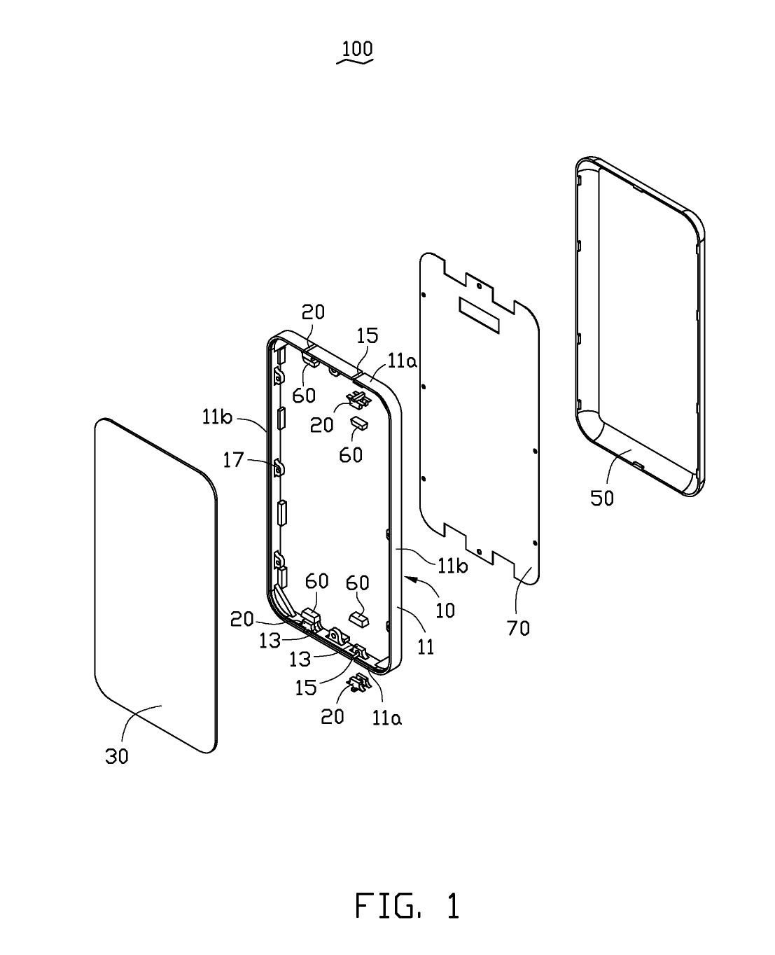

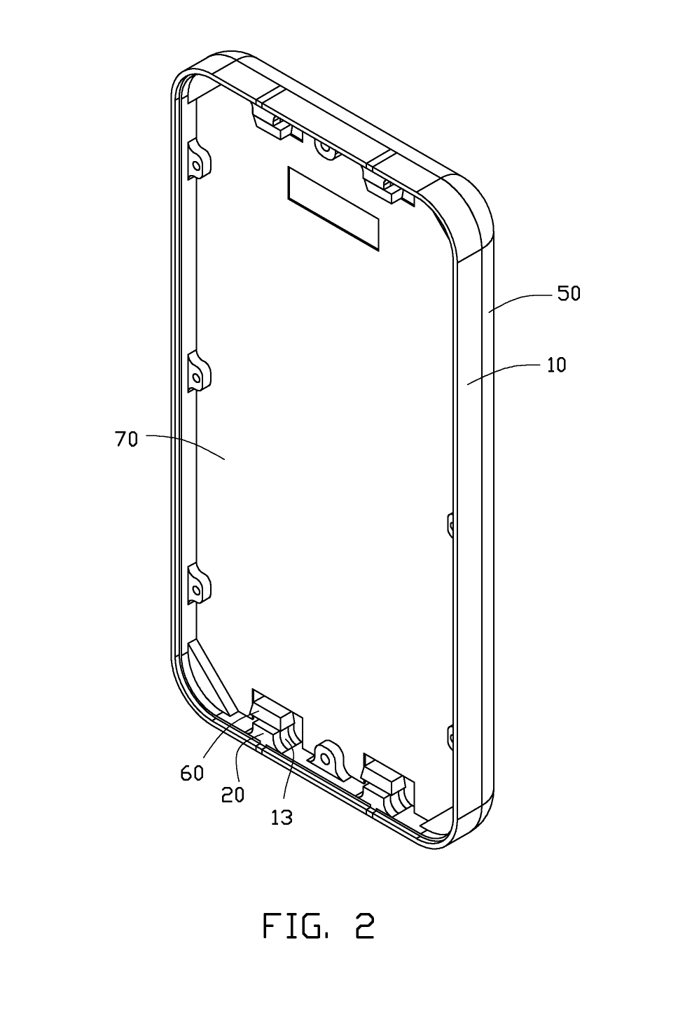

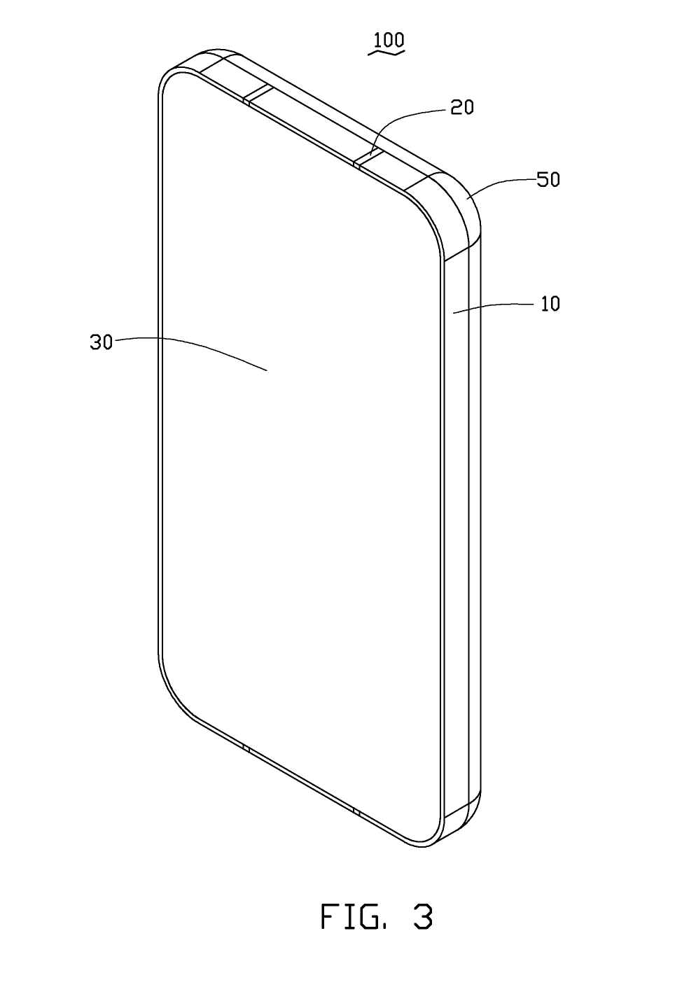

FIGS. 1-3 show a housing 100 according to an exemplary embodiment. The housing 100 may be used in a mobile phone or other portable electronic devices. The housing 100 includes a frame 10, a front cover 30, and a rear cover 50. The front cover 30 and the rear cover 50 are attached to the two opposite sides of the frame 10, thereby forming a receiving space (not shown) to receive electronic elements (such as a printed circuit board (PCB) 70 shown in FIG. 1) of the electronic devices.

The frame 10 is made of wood. The wood may define a natural wooden texture, which provides the housing 100 with an aesthetic appearance. In the exemplary embodiment, the frame 10 includes four sidewalls 11 connected to each other end-to-end. The four side walls 11 include a first set of opposite sidewalls 11a and a second set of opposite sidewalls 11b. Each sidewall 11 has an internal surface and an exterior surface. At least one protrusion 13 protrudes from the internal surface of each of the first set of opposite sidewalls 11a. In the exemplary embodiment, there are two pairs of protrusions 13 protruding from the internal surfaces of each of the first set of opposite sidewalls 11a. Through grooves 15 are defined in the sidewalls 11a at positions adjacent and perpendicular to each protrusion 13. Each through groove 15 aligns with a corresponding protrusion 13 and extends into the corresponding protrusion 13.

Corresponding to each protrusion 13, a transparent plastic article 20 is molded on the internal surface of the sidewall 11. Each plastic article 20 includes a first part engaging in a corresponding through groove 15, and two second parts on the first part and a receiving groove defined therein, for completely receiving a corresponding protrusion 13.

Corresponding to each transparent plastic article 20, a LED lamp 60 is defined in the receiving space and faces the plastic article 20. Each LED lamp 60 and a corresponding transparent plastic article corporately define a gap between the LED lamp 60 and the transparent plastic article 20. The LED lamps 60 electrically connect the PCB 70. The LED lamps 60 may be located on the PCB 70. When the LED lamps 60 emit light, the light transmits through the transparent plastic articles 20 to the outside of the housing 100, thereby highlighting the wooden textures of the frame 10, and making the housing 100 present a luxurious and aesthetic appearance.

A plurality of fastening members 17 protrude from the internal surfaces of the other set of sidewalls 11b. The fastening members 17 are used for engaging or fastening electronic elements in the receiving space (not shown).

The front cover 30 can be a display screen or a touch panel of the electronic device. The front cover 30 may be made of glass. The rear cover 50 may be made of wood, glass, ceramic, or plastic. Since the entire housing 100 is made of non-magnetic materials, electromagnetic interference problems of the housing 100 are avoided.

The exterior surface of the sidewalls 11 is carved to display patterns, thus the wooden sidewalls 11 beautify the appearance of the housing 100.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A housing of an electronic device, comprising:
a frame comprising a plurality of first opposite and second opposite sets of sidewalls; and
a front cover and a rear cover attached to two opposite sides of the frame to define a receiving space;
wherein the frame is made of wood, at least one sidewall defines at least one through groove, and a transparent plastic article is engaged in each through groove, at least one LED lamp is located in the receiving space, and each LED lamp faces the one transparent plastic article.

2. The housing as claimed in claim 1, wherein the frame comprises four sidewalls connected to each other end-to-end.

3. The housing as claimed in claim 1, wherein each sidewall has an internal surface and an exterior surface, the frame further comprises at least one protrusion protruding from the internal surface of the one of the first set of opposite sidewalls, each protrusion having the through groove aligned with and extending into a corresponding protrusion.

4. The housing as claimed in claim 3, wherein each plastic article comprises a first part engaging in a corresponding through groove, and two second parts locating on the first part and defining a receiving groove for completely receiving a corresponding protrusion.

5. The housing as claimed in claim 1, wherein a printed circuit board is received in the receiving space.

6. The housing as claimed in claim 5, wherein the sidewalls include a second set of opposite sidewalls from which extend a plurality of fixing members for engaging the printed circuit board in the receiving space.

7. The housing as claimed in claim 5, wherein the at least one LED lamp electronically connects the printed circuit board.

8. The housing as claimed in claim 1, wherein the front cover is made of glass.

9. The housing as claimed in claim 1, wherein the rear cover is made of wood, glass, ceramic, or plastic.

10. The housing as claimed in claim 1, wherein the frame is made of a wood defining a wooden texture.
